(19) United States
(12) Patent Application Publication
(10) Pub. No.: US 2019/0205892 A1
(43) Pub. Date: Jul. 4, 2019

(54) ASSOCIATING A LOCATION WITH A TROUBLE TICKET BASED ON ROUTE DATA FOR A SERVICE CREW

(71) Applicant: Florida Power & Light Company, Juno Beach, FL (US)

(72) Inventors: Guillermo Aleman, Miami, FL (US); Ronald A. Capute, Palm Beach Gardens, FL (US); Eric Davis Schwartz, Palm Beach Gardens, FL (US); Carmen J. Seppy, Palm Beach Gardens, FL (US); Alexandra J. Hayes, West Palm Beach, FL (US)

(21) Appl. No.: 15/861,171

(22) Filed: Jan. 3, 2018

(51) Int. Cl. G06Q 30/00; G06F 17/30

(52) U.S. Cl. CPC G06Q 30/016; H02J 13/0013; G06F 17/30241

(57) ABSTRACT

A ticket location system can match each of a plurality of trouble tickets stored in a plurality of electronic records of a first set of electronic records issued for power grid elements of a power grid with a corresponding instance of route data stored in an electronic record of a second set of electronic records. Each instance of route data characterizes a time and date of a route traversed by a service crew during field service of the corresponding trouble ticket. The ticket location system can identify a stop characterized in each instance of the route data. The stop is at least one of a longest stop in the instance of route data and a stop with a duration that exceeds a predetermined amount of time. Additionally, the ticket location system can associate each of the plurality of trouble ticket with a location and a time of the stop in the corresponding route data.

### TECHNICAL FIELD

The present disclosure relates to systems and methods for associating a location with a trouble ticket.

### BACKGROUND

Electrical power distribution grids can be implemented as radial, loop or network type systems. The distribution grids are arranged and interconnected to a substation in different ways depending on the type of system configuration. However, for each type of distribution system configuration, the distribution circuits (commonly referred to as feeders and lateral feeders) distribute power delivered from the substation to loads at premises coupled to the grid through smart meters.

Various types of faults can occur in a power grid, some of which result in power outages (the loss of electric power service to customers). For example, a short circuit fault causes a protective element upstream of the fault to open isolating the short circuit fault from the grid. As one example, a short circuit may be caused by a tree branch contacting power lines during a storm. Customers downstream of the opened protective element become de-energized resulting in an outage. Another type of fault is an open conductor element fault that similarly causes the downstream customers to experience a power outage. An open conductor element may be caused by a power line snapping during a storm, or a coupling joining two power lines becoming deficient and then failing thereby resulting in the open conductor.

A ticket system (which may also be referred to as an issue ticket system, a trouble ticket system, support ticket system, request management or incident ticket system) is a computer software package that manages and maintains lists of issues, as needed by an organization. Ticket systems are commonly employed to create, update and resolve reported issues identified in trouble tickets.

### SUMMARY

One example relates to a non-transitory machine readable medium having machine executable instructions. The machine executable instructions includes a ticket location system that matches each of a plurality of trouble tickets stored in a plurality of electronic records of a first set of electronic records issued for power grid elements of a power grid with a corresponding instance of route data stored in an electronic record of a second set of electronic records. Each instance of route data characterizes a time and date of a route traversed by a service crew during field service of the corresponding trouble ticket. The ticket location system identifies a stop characterized in each instance of the route data. The stop is at least one of a longest stop in the instance of route data and a stop with a duration that exceeds a predetermined amount of time. Additionally, the ticket location system associates each of the plurality of trouble tickets with a location and a time of the stop in the corresponding route data.

Another example relates to a system that includes a memory for storing machine executable instructions and a processing unit including one or more processor cores that access the memory and executes the machine readable instructions. The machine readable instructions include a ticket location system that matches a trouble ticket stored in a first electronic record issued for a power grid element in a power grid with an instance of route data stored in a second electronic record. The instance of route data characterizes a time and date of a route traversed by a service crew during field service for the trouble ticket. The ticket location system identifies a stop characterized in the instance of the route data. The stop is at least one of a longest stop in the instance of route data and a stop with a duration that exceeds a predetermined amount of time. The ticket location system associates the trouble ticket with a location and a time of the stop in the instance of the route data. The machine readable instructions also include a map system that outputs a map characterizing a geographical representation of a portion of the power grid. The map includes visual indicia for the trouble ticket positioned at a location on the map corresponding to the location of the stop associated with the trouble ticket.

Yet another example relates to a method of initiating a preventative repair procedure for a power grid element. The method includes comparing a plurality of utility server initiated trouble tickets stored in a first set of electronic records that are associated with power grid element events in a power grid with instances of route data stored in a second set of electronic records that characterize routes traversed by a plurality of service crews responding to each of the plurality of trouble tickets to determine service crew stops and locations of the service crew stops. The method also includes initiating, at a map system operating on the utility server, the preventative repair procedure for a given location for a given power grid element in response to an indication output by the map system that at least one service crew stopped at or near the given location during field service of a given trouble ticket of the plurality of trouble tickets.

### BRIEF DESCRIPTION OF THE DRAWINGS

FIG. 1 illustrates an example of a system that associates trouble tickets for power grid element events with a location or multiple locations.

FIG. 2 illustrates example of a power distribution system that associates trouble tickets for power grid element events with a location or multiple locations.

FIG. 3 illustrates a screenshot of a map system that outputs visual indicia representing trouble tickets and associated locations.

FIG. 4 illustrates another screenshot of a map system that outputs visual indicia representing trouble tickets and associated locations and visual indicia representing potential trouble areas.

FIG. 5 illustrates an example of a method for associating a trouble ticket with a location.

FIG. 6 illustrates an example of a method for initiating a preventative maintenance procedure.

### DETAILED DESCRIPTION

This disclosure relates to a ticket location system that matches trouble tickets issued for power line feeders and/or laterals with locations. More particularly, upon generation of a trouble ticket for a power grid element, such as a feeder or lateral, a service crew is dispatched to investigate the problem in the trouble ticket. The service crew has a positioning system that records a route traveled by the service crew. In many situations, to execute field service for the trouble ticket, the service crew stops one or more times to identify a problem, addresses the problem and closes the trouble ticket.

The ticket location system identifies the location of the service crew each time the service crew stops during execution of a field service for a particular trouble ticket. Each time the service crew stops for an amount of time above a predetermined threshold or stops for the longest duration during execution of the field service for the trouble ticket, the location of the stop and a time stamp (e.g., date and time) are recorded by the ticket location system and associated with the trouble ticket.

The ticket location system can provide the data to another system, such as a mapping system that can aggregate the data over the course of a given amount of time (e.g., a year). Accordingly, over the given amount of time, multiple trouble tickets may be issued for the same power grid element (e.g., the same feeder or lateral). In such a situation, the data provided by the ticket location system can be aggregated to determine if certain locations are “trouble areas” for the power grid. The mapping system can output visual indicia (e.g., a heat map) that identifies the trouble areas. For instance, if a given lateral has five (5) trouble tickets serviced in a year, and four (4) service crews fix a problem at the same location, there is likely a recurring problem at that same location (e.g., a faulty splice, interfering tree, etc.). In such a situation, the mapping system can generate a request for preventative maintenance or repair at the location.

Further, in some examples, the data output by the ticket location system is employed to determine the age of devices. For instance, if a given trouble ticket requests replacement of a particular device (e.g. a splice, a disconnect switch, etc.), and is matched with a particular location by the ticket location system, the recorded time stamp can indicate the age of the device.

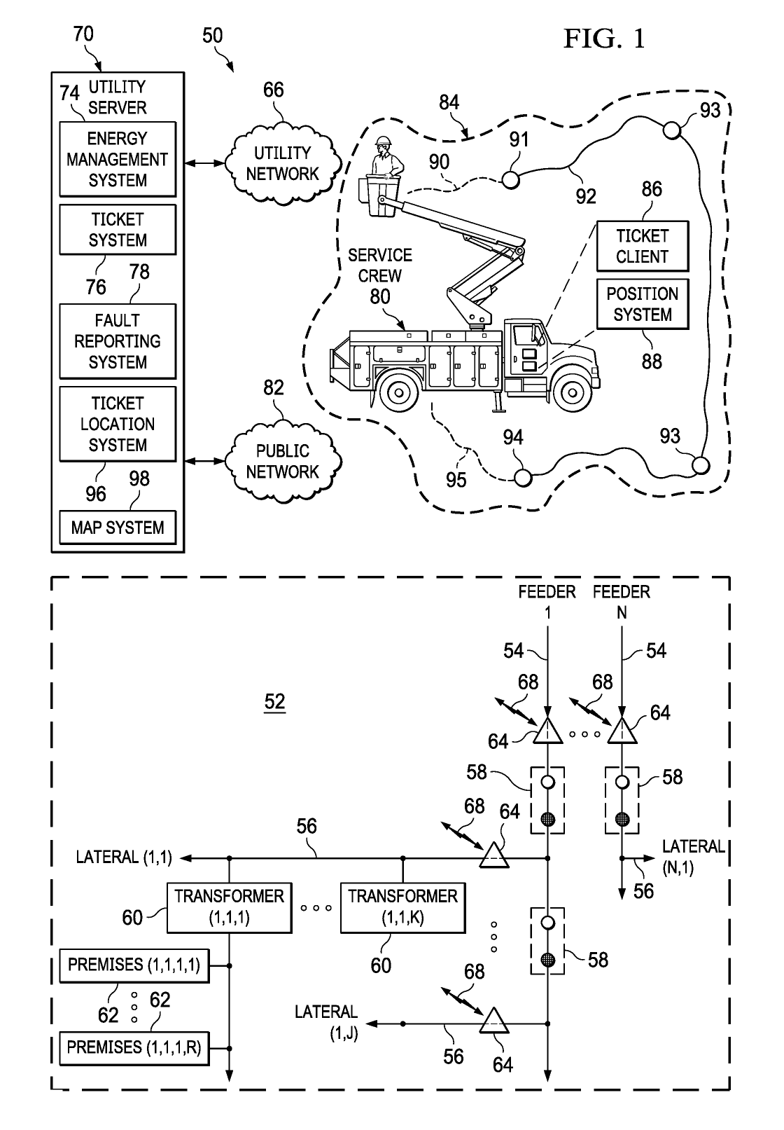

FIG. 1 illustrates an example of a system 50 that can associate trouble tickets with a (specific) location (or multiple locations). The system 50 includes a power grid 52. For purposes of simplification of explanation, only some of the elements of the power grid 52 are illustrated. However, it is understood, that elements of the power grid 52 that are not shown in FIG. 1 can be implemented in a similar or different manner.

The power grid 52 can include N number of feeders 54 that distribute electric power, where N is an integer greater than or equal to one. Each of the N number of feeders 54 receives power from a substation coupled (via an electric power line) to the power generation source. Each feeder 54 can be formed as a powerline (e.g., an electric power line). Moreover, each of the N number of feeders 54 can include J number of laterals 56, where J is an integer greater than or equal to one. In the examples illustrated, a disconnect switch 58 is logically positioned upstream from each of the J number of laterals 56, but other arrangements are possible.

Each of the J number of laterals 56 is coupled to K number of transformers 60 (distribution transformers), where K is an integer greater than or equal to one. Moreover, each of the transformers 60 are coupled to R number of power consuming premises 62 (“premises 62”), where R is an integer greater than or equal to one. Each of the power consuming premises 62, or some subset thereof, includes a smart meter. For purposes of simplification of explanation, it is presumed that communications with each premises 62 could be with the smart meter or with a person. Each power grid element (e.g., an electrical component) in the power grid 52 has a logical position and a physical location (hereinafter, referred to a “location”). Moreover, the logical position of each power grid element is identifiable by an index number and a unique alpha numeric value. The index number of a given component identifies upstream components of the given component. For example, the Jth lateral 56 on the first feeder 54 can be referenced as lateral (1,J). Similarly, the Rth premises 62 coupled to the first transformer 60, the first lateral 56 and the first feeder 54 can be referred to as premises (1,1,1,R). Thus, the index number identifies the logical position of each power grid element. Moreover, it is understood that in some examples, a network address (e.g., an Internet Protocol (IP) address) can be employed as a unique identifier of a power grid element. In such a situation, the network address can be cross-referenced to an index number.

Each feeder 54 and lateral 68 (or some subset thereof) has a fault indicator 64 installed that detects faults. The fault indicators 64 can wirelessly communicate with a utility network 66, as indicated by lines 68. The fault indicators 64 may be integrated with circuit breakers, a fault current indicator (FCI), an automated feeder switch (AFS), a Scada-Mate® switch or nearly any device that detects a fault.

A utility server 70 is also coupled to the utility network 66. The utility server 70 can be representative of a plurality of servers (e.g., a server farm) executing application software implemented to facilitate operations of a utility provider (e.g., a power company). The plurality of servers represented by the utility server 70 could be local computer devices (e.g., server blades) operating at a single facility and/or distributed across multiple facilities, such as in a computing cloud.

The utility server 70 can include an energy management system (EMS) 74 that receives the data characterizing the detected voltage and current from each of the fault indicators 64 (or some subset thereof). The EMS 74 employs the data characterizing the detected voltage and current to populate a status table that maps each fault indicator 64 with a corresponding feeder 54, lateral 56 and disconnect switch 58. Additionally, based on the data characterizing the detected voltage and current at a given fault indicator 64, the EMS 74 determines a status for each feeder and lateral. Similarly, the EMS 74 receives data characterizing a detected voltage and current from each fault indicator of the transformers 60. Furthermore, in some examples, fault indicators at the premises 62 (or a subset of the premises 62) can also provide data characterizing a detected voltage and current at a corresponding premises 62.

In a first situation, a given fault indicator 64 provides data indicating that a detected electrical voltage on a given feeder 54 is at or above the threshold voltage level (e.g., about 1 to 40 kilovolts (kV)). In the first situation, the data provided by the given fault indicator 64 indicates that the detected electrical current on the given feeder 54 is below the threshold current level (e.g., at about 0 ampere (A)). Accordingly, in the second situation, the EMS 74 can determine that a fault is present on the associated feeder 54 or lateral 56.

Further, in a second situation, the given fault indicator 64 provides data indicating that a detected electrical voltage (relative to a ground plane) on a feeder 54 or lateral 56 is below the threshold voltage level (e.g., about 1 to 40 kilovolts (kV)). Alternatively, in the second situation, the given fault indicator 64 may not provide an update within a predetermined amount of time (e.g., a timeout). In the second situation, the data provided (or not provided) by the given fault indicator 64 indicates that the detected electrical current on the feeder 54 is at or below the threshold current level (e.g., at about 0 ampere (A)). Accordingly, in the second situation, the EMS 74 may determine that a fault has occurred upstream of the given fault indicator 64. Similarly, the EMS 74 may receive data characterizing a fault indication from one of the transformers 60 and/or a premises 62.

In response to a fault indication from either (or multiple instances of) a fault indicator 64, the EMS 74 can provide a grid event identifier (e.g., which may be referred to as a fault identifier) to a ticket system 76 of the utility server 70. The power grid element event identifier include data characterizing a type of the power grid element event (e.g., a fault). The power grid element event identifier also includes an identifier (e.g., the type of device) of the power grid element associated with the power grid element event (e.g., a fault) as well as a logical location (e.g., the index number) and/or a location identifier of the power grid element associated with the power grid element event.

The utility server 70 can also include a fault reporting system 78. The fault reporting system 78 is implemented as (or a constituent component of) an automated telephone system that allows individual customers and/or service crew members to manually report a fault. After a predetermined amount of time (e.g., about 10 minutes), the fault reporting system 78 examines a list of outstanding reported faults and generates a power grid element event identifier based on a hierarchical relationship. For instance, if a customer associated with premises (1,1,1,1) and premises (1,1,1,4) both report a fault, the fault reporting system 78 may generate a power grid element event identifier for the transformer (1,1,1), since both premises (1,1,1,1) and premises (1,1,1,4) are coupled to the transformer (1,1,1). Similarly, if a customer at premises (1,1,1,1) and premises (1,1,K,3) report a fault, the fault reporting system 78 may generate a power grid element event identifier for the lateral (1,1), since both the premises (1,1,1,1) and premises (1,1,K,3) are coupled to the lateral (1,1). The power grid element event identifier generated by the fault reporting system 78 includes data similar to the power grid element event identifier generated by the EMS 74. Such data can include a device identifier and a logical position of the electrical device corresponding to the power grid element event (e.g., a fault).

In response to a power grid element event identifier, the ticket system 76 generates a trouble ticket for the power grid element associated with the power grid element event. As used herein, the term “trouble ticket” denotes an instance of data stored in an electronic record with fields that provide information employable to resolve an issue with the trouble ticket. Each trouble ticket can be stored in a data structure, such as a database or table. As an example, fields of a trouble ticket for a given power grid element can include but are not limited to, a timestamp, a device identifier, a logical position of the given power grid element, etc. The trouble ticket for the given power grid element can also include location data characterizing a location for the given power grid element. In examples where the power grid element is a smart meter associated with a premises 62, the location for the given component can be a civic address of the premises. In examples where the given power grid element is a transformer 60, the location can be latitude and longitude coordinates of the transformer 60. Similarly, in examples where the given power grid element is a fault indicator installed on a feeder 54 or lateral 56, the location in the trouble ticket may be latitude and longitude coordinates of the fault indicator, and/or a splice associated with a feeder 54 or lateral 56. In some examples, the existence of splices and/or their locations may not be recorded. In many examples, the location data included with the trouble ticket is at least one of inaccurate and incomplete. For instance, providing a location of a fault detector 64 of a feeder 54 may have an inaccuracy up to about the length of the entire feeder 54 (e.g., 20 or more kilometers).

A service crew 80 communicates with the ticket system 76 via a public network 82 (e.g., the Internet). The term “service crew” denotes machinery, tools and/or human resources needed to resolve issues throughout the power grid 52. The service crew 80 is assigned a unique identifier, such as a crew identifier (ID). The service crew 80 includes a vehicle (e.g., service truck) that can be dispatched to provide service for trouble tickets. The crew ID uniquely identifies one or more persons within the service crew and/or the associated vehicle. The service crew 80 travels within a geographic region 84 that represents an area that is serviced by the power grid 52, or some subset thereof. For purposes of simplification of explanation, only one service crew 80 is illustrated. However, it is understood that in some examples, multiple service crews (e.g., 100 or more) may be implemented to provide field service for the power grid 52.

The service crew 80 includes a computer system with a ticket client 86 operating thereon. The computing system could be, for example, a mobile device (e.g., a tablet computer), a laptop computer, a desktop computer or a proprietary hardware device. The ticket client 86 receives trouble tickets from the ticket system 76 that are assigned to the service crew 80. Upon receipt of a particular trouble ticket, a user (e.g., a member of the service crew) can provide an indication (e.g., user input into the computing system) that the service crew 80 is executing field service (e.g., a service call) for the particular trouble ticket.

The computing system also includes a position system 88 that tracks a real-time (e.g., within about 10 seconds) location of the service crew 80. The real-time location be, for example, geographic coordinates (e.g., latitude and longitude coordinates) and speed of the service crew. The position system 88 can be implemented as a global location navigation satellite system (GNSS), such a global positioning system (GPS) or Galileo. The position system 88 can continuously or intermittently record a time and location of the service crew 80.

In a first example (hereinafter, “the first example”), is it presumed that the service crew 80 receives a trouble ticket for the lateral (1,1) that corresponds to a fault reported by the fault indicator 64 installed on lateral (1,1). In the first example, it is presumed that the service crew 80 travels along a routes within the geographic region 84. More specifically, it is presumed that the service crew 80 travels along a route 90 to a location indicated at 91. At the location 91, a user (a service crew person) employs the ticket client 86 to indicate that the service crew 80 is executing field service for the trouble ticket for the lateral (1,1) at a given instance in time. In some examples, in response, the position system 88 associates a segment (partition) of travel, namely a route indicated by 92 with the trouble ticket.

To execute the field service for the trouble ticket the service crew 80 travels along the route 92 to identify and repair the power grid element along the lateral (1,1) that caused the fault indicated in the trouble ticket. In the first example, it is presumed that the route 92 corresponds to a geographic area serviced by the lateral (1,1). Thus, the route 92 may be 1-7 kilometers (about 0.6 miles to about 4.2 miles). In the first example, along the route 92, the service crew makes two (2) short stops indicated at 93, and the position system 88 records the location and duration of each short stop 93. As used herein, the term “short stop” is a stop (e.g., where the speed of the service crew is 0) of the service crew 80 for less than a predetermined amount of time (e.g., 15 minutes) and/or a stop that has a shorter duration than a longest stop on the route traversed during execution of field service of a trouble ticket. One example of a short stop 93 includes a stop of the service crew 80 at a traffic light or sign. Another example of a short stop 93 is an investigation of an power grid element on the lateral (1,1) (e.g., a splice) that is not a cause of the fault (e.g., the power grid element is functioning properly).

Furthermore, in the first example, the service crew 80 makes a long stop indicated at 94 along the route 92. As used herein, the term “long stop” denotes that the stop (e.g., where the speed of the service crew is 0) is the longest stop made along the route traversed during execution of the field service for the trouble ticket and/or a stop that exceeds the predetermined amount of time. The long stop may be made by the service crew 80, for example, to correct a condition that is causing the fault indicated in the trouble ticket. The correction of the condition, can include, for example, resetting, repairing or replacing an electrical device (e.g., a splice, a disconnect switch, a transformer, etc.). Alternatively, correction of the condition can include cutting of vegetation (e.g., tree branches) that may be contacting the lateral (1,1). Upon correcting the condition, the user (e.g., the service crew person) can provide user input to the ticket client 86 indicating that fault for the trouble ticket has been cleared, and that the trouble ticket is to be closed. The user input can be provided to the ticket system 76, and the trouble ticket can be closed. In some examples, the user input to the ticket client 86 can include information (e.g., text or other input) that characterizes a final cause of a fault, as determined by the service crew 80 for the trouble ticket. In other examples, the final cause could be entered by an operator of the ticket system 78. The final cause may be, for example, a faulty splice, a broken power line, excessive vegetation, etc. In such a situation, the ticket system 76 can store a field characterizing the final cause with the closed trouble ticket. In the first example, after closing the trouble ticket, the service crew 80 traverses a route indicated at 95 to provide field service for a second trouble ticket or to return to the dispatch center.

Upon returning to the dispatch center, the position system 88 provides route data for the service crew 80 to a ticket location system 96. As used here, the term “route data” denotes data stored in an electronic record with fields that characterize geographic coordinates, speed and timestamps of a route of travel. In one example, fields of the route data includes data characterizing the entire route traversed by the service crew 80 during a work shift. As used herein, the term “work shift” denotes a time a given service crew leaves the dispatch center until the service crew returns to the dispatch center (or some subset thereof). Thus, in the first example, the route data would include routes 90, 92 and 95. Moreover, the route data includes a list of stops and associated durations, including the location and duration of the short stops 93 and the long stop 94. The ticket location system 96 can store the route data. As noted, there may be multiple service crews. Thus, the ticket location system 96 can store the route data for multiple work shifts of multiple service crews.

Alternatively, in response to the request to close the ticket, the position system 88 can send route data to a ticket location system 96 executing on the utility server 70 that includes a partition of the route traversed during a work shift that is associated with a particular trouble ticket. For instance, in some examples, the position system 88 may send an identifier of the trouble ticket (e.g., the trouble ticket number) and the route data that characterizes the route 92 (omitting data characterizing the routes 90 and 95). In this situation, the route data characterizes the route 92, as well as a time and duration of each stop (the short stops 93 and the long stop 94) along the route 92.

In some examples, the ticket system 76 and the ticket location system 96 can operate independently. That is, the ticket system 76 and the ticket location system 96 can operate as independent data gathering (e.g., data accumulation and processing) systems. In other examples, the ticket system 76 and the ticket location system 96 can operate as constituent components of another system.

Periodically (e.g., once per day) or asynchronously (e.g., in response to a request) the ticket location system 96 attempts to correlate a location to a closed trouble ticket. In particular, the ticket location system 96 retrieves closed trouble tickets from the ticket system 76. The ticket location system 96 matches a route of a particular service crew to that was assigned to a particular trouble ticket based, for example, on the crew ID in the closed trouble ticket. For instance, in the first example, the ticket location system 96 may match the electronic record with route data that characterizes the route indicated at 90, 92 and 95 traversed by the service crew 80 to electronic record for the trouble ticket for lateral (1,1). Additionally, the ticket location system 96 examines a beginning and end time stamp provided by the ticket client 86 of the matched service crew to identify a portion of the route data to associate with the particular trouble ticket. In the first example, the ticket location system 96 could associate the route 92 with the trouble ticket for the lateral (1,1).

It is understood that in some examples, multiple service crews 80 may be dispatched for the same trouble ticket. For instance, in a situation where the trouble ticket is issued for a given feeder 54, multiple service crews 80 may be dispatched to search an entity of the length of the feeder 54. In such a situation, route data for each service crew 80 dispatched for the trouble ticket can be aggregated and analyzed collectively.

Upon determining the portion of the route data that is associated with the particular trouble ticket, the ticket location system 96 identifies one or more long stops in the portion of the route data. As noted, each long stop is a stop during the field service of the particular trouble that either exceeds the predetermined amount of time and/or is the longest stop made during the field service for the trouble ticket. Additionally, it is presumed that the service crew corrected a fault indicated in the particular trouble ticket at the one or more long stops. The ticket location system 96 associates a location and time of each long stop with the particular trouble ticket. Additionally in some examples, the ticket location system 96 may associate the location with the final cause of the trouble ticket. In the first example, the ticket location system 96 would associate the location and time of the stop at 96 with the trouble ticket for the lateral (1,1). The ticket location system 96 can record the association between the location and time of the stop and the trouble ticket in a ticket location database (or other data structure).

Over a period of time (e.g., one or more years), many trouble tickets are issued for the power grid 52. The ticket location system 96 can record the association of the trouble ticket and the location for each of the trouble tickets generated by the ticket system 76 (or some subset thereof) over the course of the period of time in the database. In some examples, the period of time may exceed the expected life span of some (or all) of the power grid elements of the power grid 52. The ticket location system 96 can analyze historical data to determine identify “trouble areas” within the power grid 52. In particular, the ticket location system 96 can analyze records in the ticket location database to determine if trouble tickets issued for the same power grid element are associated with the same location or within a proximal (near) area (e.g., within about 0.5 kilometers). Additionally, in some examples, the ticket location system 96 can determine if the same final cause of multiple trouble tickets is associated with the same location.

For instance, in a second example (hereinafter, “the second example”), it is presumed that in the past year, twelve (12) trouble tickets have been issued for feeder 1, and seven (7) of those trouble tickets are associated with a first location. Additionally, in the second example, it is presumed that three (3) trouble tickets issued for feeder 1 are associated with a second location, and the remaining two (2) trouble tickets are associated with third and fourth locations, respectively. In the second example, the ticket location system 96 can mark the first location associated with the seven (7) trouble tickets as a “high risk trouble area” of that may need to be investigated further. Additionally, the ticket location system 96 can mark the second location associated with the three (3) trouble tickets as a “medium risk trouble area”. Similarly, the ticket location system 96 can mark the third and fourth locations that are associated with the one (1) trouble tickets as a “low risk trouble area”.

Additionally or alternatively, a risk level (high to low risk) of the trouble ticket can be based on the frequency of the same final cause being associated with the location. For instance, if multiple trouble tickets with the same final cause are associated with the same location or proximal area, the ticket location system 96 may elevate the risk level for the location or proximal area. Conversely, if multiple trouble tickets are associated with the same location or proximal area, but each trouble ticket has a different final cause, the risk level may be lowered (or remain the same).

The utility server 70 also includes a map system 98 that communicates with the ticket location system 96. The map system 98 can generate a graphical user interface (GUI) that includes a heat map showing the geographic region 84 (or some portion thereof) that is serviced by the power grid 52. Moreover, the heat map output by the map system 98 can include visual indicia (e.g., color indicators) on at specific locations power grid elements with one or more trouble tickets. For instance, in the second example, the first location associated with the seven (7) trouble tickets might be mark with a color (e.g., red) that indicates a high risk trouble area on the feeder 1. Additionally, in the second example, the second location associated with the three (3) other trouble tickets might be marked with a color (e.g., yellow) indicating a medium risk trouble area. Moreover, the third and fourth locations could be marked with a color (e.g., green or blue) indicating a low risk trouble area. It is understood that in other examples, other (or additional) indicia could be employed.

A user of the heat map provided by the map system 98 could leverage the information output to initiate investigations. Additionally or alternatively, the map system 98 may be programmed to automatically initiate investigations for trouble areas that exceed a threshold (e.g., high risk trouble areas). For instance, in the second example, upon identifying the first location of feeder 1 that is marked as a high risk trouble area, a user of the heat map and/or the map system 98 might request a preventative maintenance (and/or repair) procedure at the first location. In some examples, such requests can be provided to the ticket system 76 (or another system). Upon inspection, it may be observed that there is continued growing of vegetation (e.g., a tree branch) that repeatedly interferes with feeder 1.

Additionally, the ticket system 76 can be configured to analyze data from the ticket location system 96 to improve the accuracy and/or completeness of location data for future trouble tickets. For instance, by employment of the system 50, such future trouble tickets can be augmented to be associated with specific locations in the power grid 52. For instance, in the second example, if a future fault is detected a specific power grid element, the ticket system 76 can query the ticket location system 96 for trouble areas related to the specific power grid element. For instance, in the second example, if a future fault is detected for the feeder 1, the ticket system 76 can query the ticket location system 96 for a list of trouble areas associated with the feeder 1. In such a situation, the ticket system 76 can add the trouble areas for feeder 1 to the trouble ticket, which can improve efficiency in dispatch of the service crews.

Further, in some examples, the data output by the ticket location system 96 is employed by the EMS 74 (or other system) to determine the age of devices. For instance, if a given trouble ticket requests replacement of a particular grid component (e.g. a splice, a disconnect switch, etc.), and is matched with a particular location by the ticket location system 96, the recorded time stamp can indicate the age of the device. Thus, the EMS 74 can examine the location and time associated with the trouble ticket to determine an age of the grid component.

By employment of the system 50, a specific location can be associated with a trouble ticket. In this manner, a trouble area for a closed troubled ticket associated with a given power grid element can be reduced from a relatively large area (e.g., 20 kilometers (12 miles) or more for a feeder) to a specific location. Such information is employable to augment future trouble tickets for the same power grid element and/or to initiate preventative maintenance (repair) procedures, as described herein.

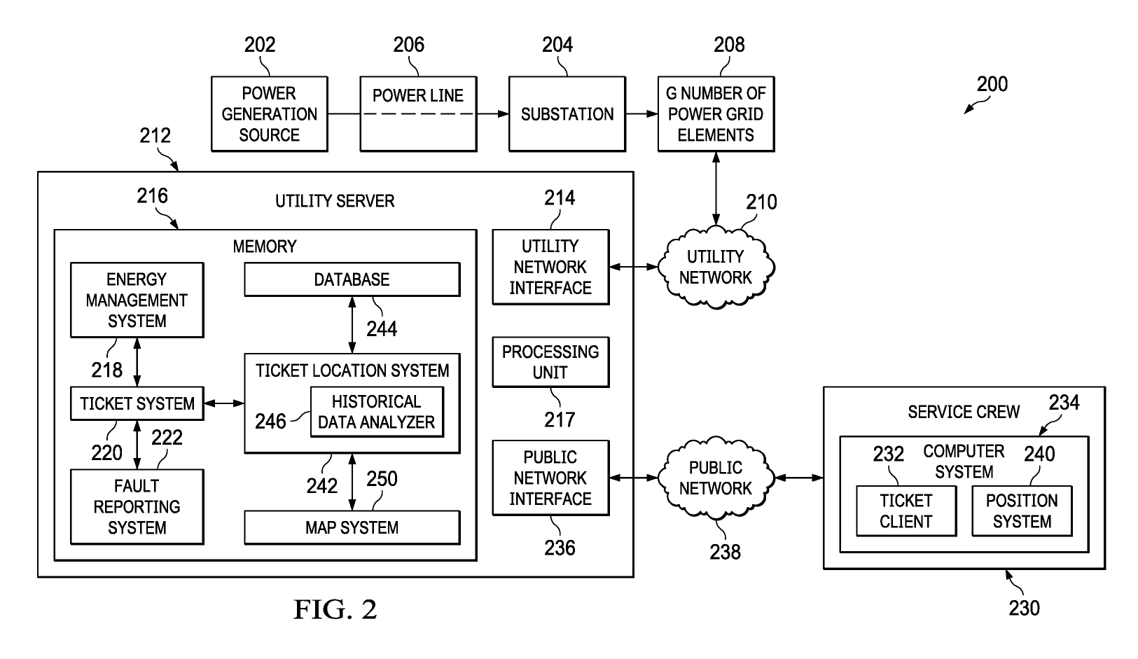

FIG. 2 illustrates an example of electric power distribution system 200 that associates a location to a plurality of trouble tickets. The electric power distribution system 200 can include a power generation source 202 that can generate electric power. The power generation source 202 could be representative of a power plant, such as a fossil fuel or coal-fired plant, a nuclear plant, a wind farm and/or a solar array and attendant constituent structures or any combination thereof. The power generation source 202 can transmit a high-voltage, alternating current (AC) power (such as 115 or 220 kilovolt (kV) AC power) to a substation 204 via a power line 206 (e.g., an electric power line).

The substation 204 can transform the high voltage AC power into mid-voltage power. For example, it may be desirable in some circumstance to step down (or to step up) voltage via one or more substation 204 power grid elements, to phase-shift and/or otherwise adjust current phase or amplitude, for instance, to achieve a desired power function as specified by the kind of load and/or to minimize energy lost in the electric power distribution system 200. It is noted that the electric power distribution system 200 may include more than one power generation source 202 and/or more than one substation 204. The substation 204 can distribute electric power to G number of power grid elements 208 that form a power grid or a partition of a power grid.

The electric power distribution system 200 includes G number of power grid elements 208. The G number of power grid elements 208 can include the grid elements (electrical components) illustrated in the power grid 52 of FIG. 1, where G is an integer greater than one. For example, each of the G number of power grid elements can be feeders, lateral, disconnect switches, transformers, smart meters at premises, etc. Each of the G number of power grid elements 208 has a logical position that can be identified with an index number and a (physical) location.

Each of the G number of power grid elements 208 (or some subset thereof) are be communicably coupled to the utility network 210 such that (network) messages including usage data collected (and possibly processed) grid elements may be transmitted to the utility network 210. The utility network 210 can be, for example, a mesh network or a point-to-point network. In some examples, the utility network 210 can be implemented as a packet-switched network, such as an Internet Protocol (IP) network, including an IP version 6 (IPv6) network. Additionally, in some examples, the utility network 210 could be coupled to the Internet or be implemented as a private proprietary network.

A utility server 212 (e.g., a computer system) is connected to the utility network 210 via a utility network interface 214 (e.g., a network interface card). In this manner, the utility server 212 can establish bi-directional communication with each of the G number of power grid elements 208 (or some subset thereof) via the utility network 210. The utility server 212 can be implemented by a utility provider (e.g., a power provider), such as a utility provider that controls the power generation source 202. The utility server 212 can include memory 216 that stores machine executable instructions. The memory 216 can be implemented as a non-transitory machine readable medium. The memory 216 could be volatile memory (e.g., random access memory), non-volatile memory (e.g., a hard drive, a solid state drive, flash memory, etc.) or a combination thereof. The utility server 212 can include a processing unit 217 (e.g., one or more processor cores) that accesses the memory 216 and executes the machine readable instructions.

In some examples, the utility server 212 can be (physically) implemented at facilitates controlled by the utility provider. In such a situation, the utility server 212 could be representative of multiple servers (e.g., a server farm). Additionally or alternatively, the utility server 212 (or a portion thereof) can be implemented in a remote computing system, such as a computing cloud. In such a situation, features of the utility server 212, such as the processing unit 217 and the memory 216 could be representative of a single instance of hardware or multiple instances of hardware with applications executing across the multiple of instances (i.e., distributed) of hardware (e.g., computers, routers, memory, processors, or a combination thereof). Alternatively, the utility server 212 could be implemented on a single dedicated computing device.

The memory 216 can store application software for controlling operations of the utility provider. For example, the memory 216 can store application software for processing and billing systems, various monitoring, customer service, troubleshooting, maintenance, load balancing, accounting, and other types of activities that may be used to operate a utility provider.

As one example, the memory 216 can include an EMS (energy management system) 218. The EMS 218 receives time-stamped information characterizing an incoming voltage level corresponding to a voltage and/or a current (e.g., amperes) at each of the G number of power grid elements 208 (or some subset thereof). In response to receiving an indication of an anomalous voltage or current from a given power grid element of the G number of power grid elements 208, the EMS 218 can determine that the given power grid element is experiencing a fault. Alternatively, some of the G number of power grid elements 208 may include logic for detecting a fault, and the fault is reported to the EMS 218. In response to the detection of a fault, the EMS 218 generates a power grid element event identifier. The power grid element event identifier include data characterizing a type of the power grid element event (e.g., a fault). The power grid element event identifier also includes a device ID for the given power grid element of the G number of power grid elements 208, including a logical location, location data (which may be incomplete and/or inaccurate) of the given power grid element and a time stamp. The EMS 218 provides the power grid element event identifier to a ticket system 220.

The memory 216 can also include a fault reporting system 222. The fault reporting system 222 is implement as (or a constituent component of) an automated response system that allows individual customers and/or service crew members to manually report a fault. The fault may be reported by telephone, email, text message, etc. In response to report of a fault, the fault reporting system 222 determines a power grid element of the G number of power grid elements 208 that is experiencing a fault and generates a power grid element event identifier. The power grid element event identifier generated by the fault reporting system 222 includes data similar to the power grid element event identifier generated by the EMS 218. Such data can include an event type, a device identifier, a logical position and location data of the power grid element corresponding to the fault and a timestamp. The power grid element event identifier is provided to the ticket system 220.

The ticket system 220 can be configured to generate and process trouble tickets stored in electronic records. The ticket system 220 can update trouble tickets based on a status of the electric power distribution system 200. For example, the ticket system 220 can generate a trouble ticket, close a trouble ticket (e.g., mark as completed), augment a trouble ticket, etc. In response to a power grid element event identifier provided from the EMS 218, the fault reporting system 222 or another system, the ticket system 220 generates a trouble ticket for the power grid element identified in the power grid element event identifier. The trouble ticket for a given power grid element can include, but is not limited to a timestamp, a device identifier and a logical position of the power grid element associated with the power grid element event identifier. The trouble ticket can also include information characterizing a type of issue being experienced (e.g., a fault) and/or instructions for remedying the issue (e.g., replace power grid element). Additionally, in some examples, the trouble ticket can include location data characterizing a location associated with the fault in the power grid element event identifier. The location data may be inaccurate and/or incomplete.

The ticket system 220 can control the dispatch of service crews to various locations in the electric power distribution system 200 to address the issue characterized in a particular (or multiple) trouble tickets. In FIG. 2, one (dispatched) service crew 230 is illustrated, but it is understood that in other examples, multiple service crews could be dispatched concurrently.

The service crew 230 can include a vehicle, and a mobile computing device 234 for two-way communication with the utility server 212. In some examples, the service crew 230 can include a ticket client 232 (e.g., application software) executing on the mobile computing device 234 (e.g., a smartphone, a tablet computer, a laptop computer, etc.) that can communicate with the ticket system 220. In such a situation, the utility server 212 can include a public network interface 236 (another network interface card) that can communicate with the ticket client 232 via a public network 238. The public network 238 can include, for example, the Internet, the public switched telephone network (PSTN), a carrier network, etc. The mobile computing device 234 includes a position system 240 (e.g., a GNSS) that tracks a location and corresponding time of the service crew 230.

In some examples, the service crew 230 may be assigned multiple trouble tickets. The ticket system 220 associates a crew ID of the service crew 230 with each assigned trouble ticket. Moreover, during a work shift, a crewmember of the service crew 230 employs the ticket client 232 to indicate that field service for a given trouble ticket is initiated.

To execute the field service, the service crew 230 travels to a location within the geographic region serviced by the G number of power grid elements 208. Moreover, the service crew 230 traverses (travels) a route that is recorded by the position system 240. The tracked location and time can be employed by the position system 240 to generate route data stored in an electronic records that characterizes the route traversed (including timestamps) by the service crew 230. During the traverse route, the service crew 230 may make one or more stops. Each stop is recorded by the position system 240. Upon completion of the field service, the crewmember employs the ticket client 232 to request a closing of the given trouble ticket. In some examples, the crewmember can employ the ticket client 232 to enter information (e.g., text) characterizing a determined final cause of the trouble ticket (e.g., down power line, faulty splice, etc.). In response, the ticket system 220 closes the given trouble ticket, and the closed trouble ticket is recorded. Over time, the ticket system 220 may generate and close many trouble tickets (e.g., 1,000-50,000 or more in a year).

Additionally, in response to the crewmember requesting close of the given ticket or in response to the service crew 230 ending a work shift, the position system 240 provides route data to a ticket location system 242. The ticket location system 242 is configured to associate a closed trouble ticket with a location. Accordingly, periodically and/or asynchronously the ticket location system 242 retrieves a plurality of closed trouble tickets from the ticket system 220. The ticket location system 242 attempts to match a location to each of the retrieved closed trouble tickets, or some subset thereof.

In particular, the ticket location system 242 matches a closed trouble ticket stored in an electronic record with route data stored in an electronic record recorded for a service crew identified in the closed trouble ticket. That is, the ticket location system 242 identifies route data characterizing a route traversed by the service crew during field service for the closed trouble ticket. Moreover, the ticket location system 242 parses the route data to determine one or more long stops in the route data and filters (e.g., removes) short stops in the route data. Each long stop can be a stop that exceeds a predetermined threshold or is a longest stop (in duration) during the field service for the trouble ticket. Each short stop is a stop that is shorter than the longest stop (in duration) during the field service of the trouble ticket and/or does not exceed the predetermined threshold. In the present examples, it is presumed that each long stop contributed to correcting an issue (e.g., fault) identified in the trouble ticket. Accordingly, the ticket location system 242 associates the closed trouble ticket with a location of each long stop during the field service of the trouble ticket. Additionally, in situations where the trouble ticket includes a determined final cause, the ticket location system 242 can associate the determined final cause with the location of each long stop of the service crew. The ticket location system 242 can store each closed field trouble ticket and the associated location corresponding time (or multiple locations and corresponding times) in a database (DB) 244 or other data structure (e.g., a table).

Over time, the ticket location system 242 associates many trouble tickets with locations and times. The ticket location system 242 can include an historical data analyzer 246 to identify trouble areas in the electric power distribution system 200. In particular, the historical data analyzer 246 can parse records in the database 244 to determine if multiple trouble tickets issued for the same power grid element of the G number of power grid elements 208 are associated with the same location or within a proximal area (e.g., within about 0.5 kilometers). For instance, if throughout a given year, twenty (20) trouble tickets are generated for a given power grid element and ten (10) of the trouble tickets are associated with the same location or within the proximal area, and in some examples, the same final cause, the historical data analyzer 246 may mark the location or proximal area as a “high risk trouble area”.

Additionally, continuing with this example, if three (3) of the trouble tickets are associated with the same location or within the proximal area, the ticket location system 242 may mark the location or proximal area associated with the three (3) trouble tickets as a “medium risk trouble area”. Similarly, if the remaining seven (7) trouble tickets are associated with other locations, the ticket location system 242 may mark the remaining locations as “low risk trouble areas”. It is understood that the levels corresponding to the risk of the trouble can vary based on the environment of application.

The memory 216 can also include a map system 250 that provides a GUI depicting the geographic region serviced by the electric power distribution system 200, or some portion thereof. The map system 250 can receive records (stored in the database 244) that includes trouble tickets and the associated locations. The GUI outputs a map depicting power grid elements in the electric power distribution system 200. The map includes visual indicia (e.g., icons) corresponding to locations associated with trouble tickets.

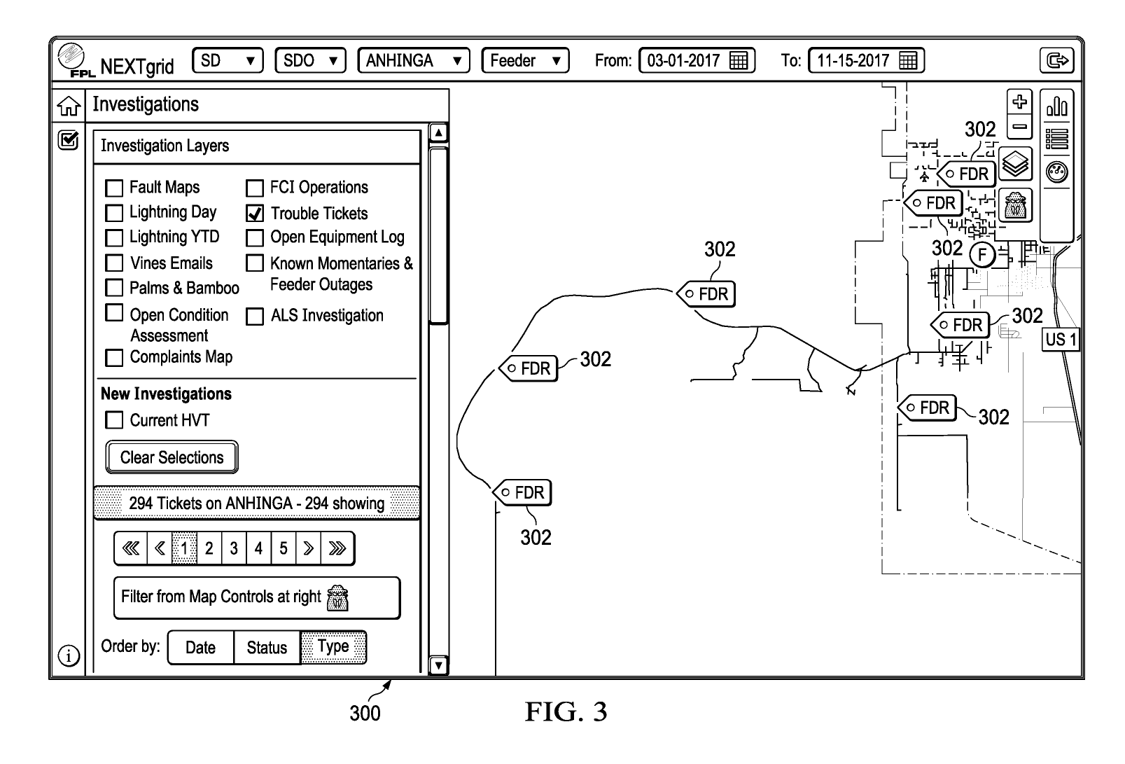

FIG. 3 illustrates an example of screenshot 300 depicting a map that could be output by the map system 250 of FIG. 2. As illustrated, there are a plurality of icons 302 that represent locations corresponding to trouble tickets. The icons 302 an identifier “FDR” that characterizes the type of power grid element corresponding to the trouble ticket (a feeder in the screenshot 300). As illustrated by the screenshot 300, a viewer of the map can quickly ascertain the physical location that is associated with closed trouble tickets within the geographic area represented by the screenshot 300.

Referring back to FIG. 2, the map provided by the map system 250 can allow a user to select a particular trouble ticket (e.g., by selecting one of the icons 302 in FIG. 3) to provide additional information related to a particular trouble ticket. Furthermore, the map output by the map system 250 can be implemented as a heat map with visual indicia representing potential trouble areas with a color corresponding to the risk level.

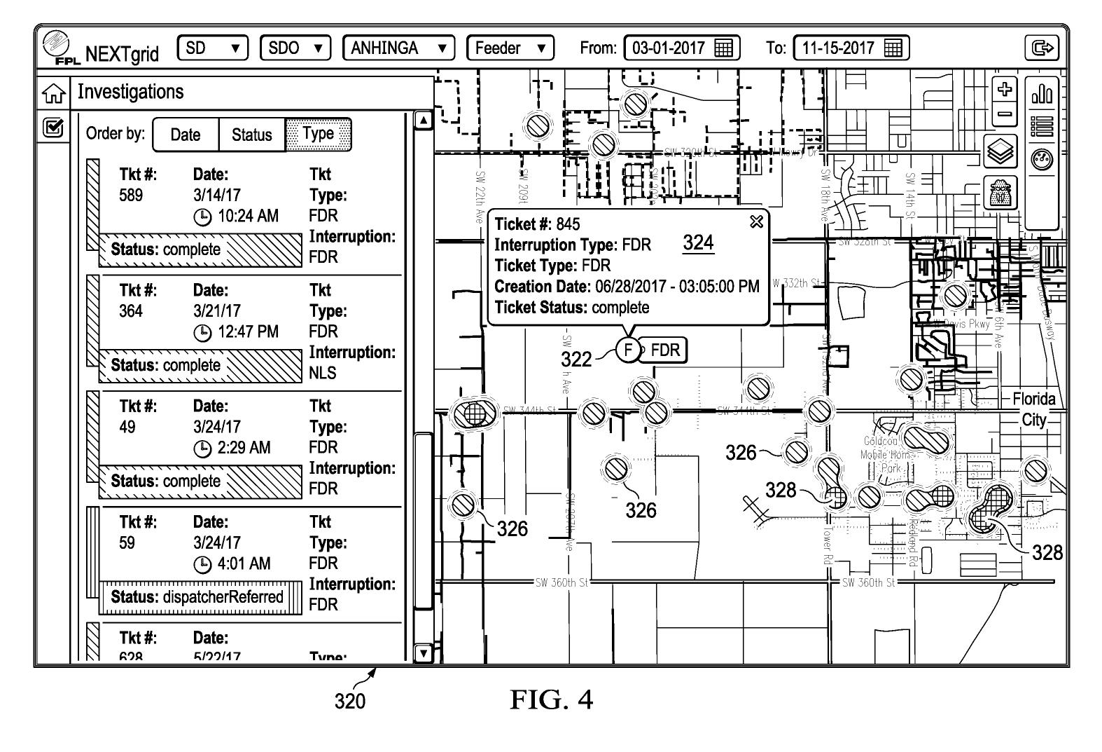

FIG. 4 illustrates an example of a screenshot 320 depicting a map that could be output by the map system 250 of FIG. 2 in response to selection of icon 322 for a given trouble ticket. Upon selection, an information box 324 is output with information related to the selected trouble ticket. Additionally, in the screenshot 320, visual indicia (e.g., “hot spots”) are output to denote potential trouble areas and a corresponding risk level. In particular, the screenshot 320 includes first indicia 326 (e.g., green spots) that indicate a low risk trouble area and second indicia 328 (e.g., yellow spots) that indicate a medium risk trouble area. Thus, a viewer of the screenshot 320 can quickly ascertain which areas need investigation.

Referring back to FIG. 2, the map system 250 (e.g., automatically and/or in response to user input) can generate a request for preventative maintenance/repair in response identifying a trouble area. In some examples, the request for preventative maintenance and/or an investigation can be provided to the ticket system 220, and a trouble ticket can be generated for the trouble area.

By employing the ticket location system 242, a more specific location for trouble tickets can be ascertained. This information can be leveraged to output in maps and/or employed to initiate investigations and/or preventative maintenance (and/or repair) procedures, even in situations where no fault is currently being experienced (e.g., preventative maintenance). Further, this information can be leveraged by the ticket system 220 to elevate the accuracy and/or completeness of the location data of future trouble tickets issued for the G number of power grid elements 208.

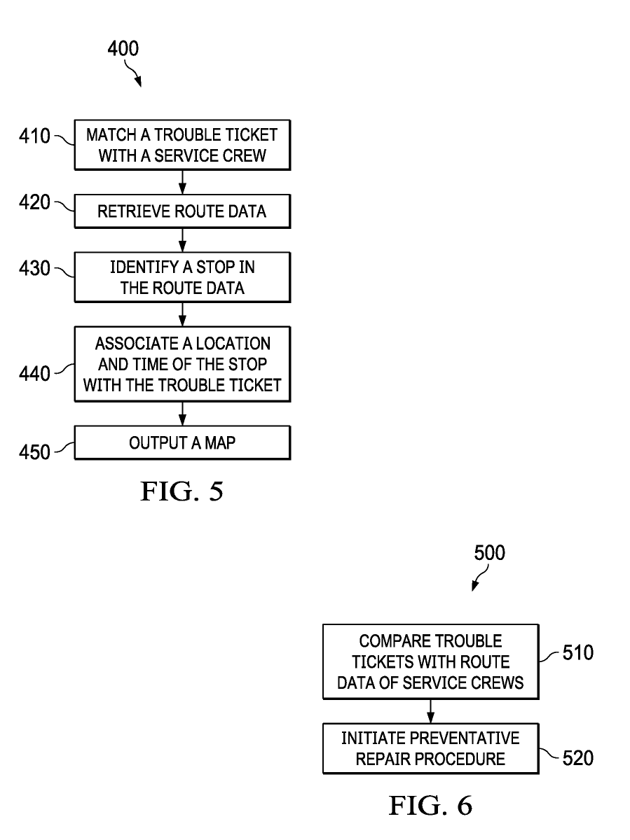

In view of the foregoing structural and functional features described above, an example method will be better appreciated with reference to FIGS. 5 and 6. While, for purposes of simplicity of explanation, the example method of FIGS. 5 and 6 is shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement a method.

FIG. 5 illustrates a flowchart of an example method 400 for determining a location associated with a trouble ticket. In some examples, the trouble ticket may have a field characterizing a final cause of the trouble ticket that is inputted by a crewmember or operator of ticket system. The method 400 can be executed by the utility server 70 of FIG. 1 and/or the utility server 212 of FIG. 2. At 410, a ticket location system (e.g., the ticket location system 96 of FIG. 1) matches a trouble ticket stored in an electronic record and is issued for a power grid element (generated in response to a power grid element event) with route data stored in an electronic record for a service crew (or multiple service crews) that provided field service for the trouble ticket. For example, at 410, the ticket location system can examine each trouble ticket issued for a feeder and/or lateral ticket and identify a crew ID assigned to each trouble ticket. At 420, the trouble ticket system retrieves route data associated with each service crew matching the crew ID assigned to the trouble ticket.

At 430, the ticket location system identifies a stop in the route data. The stop in the route data has a high degree of likelihood of being related to maintenance to remedy the issue associated with the trouble ticket. At 440, the ticket location system associates a location and time of the stop with the trouble ticket. The association of the location with the trouble ticket can include, for example, matching the final cause of the trouble ticket to the location of the stop. The association can be stored, for example, in a database. At 450, a map system (e.g., the map system 98 of FIG. 1) outputs a map with visual indicia (e.g., an icon) at a position corresponding to the location associated with the trouble ticket.

FIG. 6 illustrates a flowchart of an example method 500 for initiating a preventative repair procedure for a power grid element. The method 500 could be executed by the utility server 70 of FIG. 1 and/or the utility server 212 of FIG. 2. At 510, a ticket location system (e.g., the ticket location system 96 of FIG. 1) operating on the utility server compares a plurality of trouble tickets stored in electronic records (a first set of electronic records) that are associated with power grid element events with instances of route data stored in electronic records (a second set of electronic records) that characterize routes traversed by a plurality of service crews responding to each of the plurality of trouble tickets. At 520, a map system (e.g., the map system 98) operating on the utility server initiating, initiates a preventative repair procedure for a given location for a given power grid element in response to an indication output by the map system that at least one service crew stopped at or near the given location during field service of a given trouble ticket of the plurality of trouble tickets. .

What have been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. A non-transitory machine readable medium having machine executable instructions comprising a ticket location system that:
matches each of a plurality of trouble tickets stored in a plurality electronic records of a first set of electronic records and issued for power grid elements of a power grid with a corresponding instance of route data that is stored in an electronic record of a second set of electronic records, each instance of route data characterizing a time and date of a route traversed by a service crew during field service of the corresponding trouble ticket;
identifies a stop characterized in each instance of the route data, wherein the stop is at least one of a longest stop in the instance of route data and a stop with a duration that exceeds a predetermined amount of time; and
associates each of the plurality of trouble tickets with a location and a time of the stop in the corresponding route data.

2. The medium of claim 1, wherein the ticket location system filters short stops in each instance of the route data, wherein each short stop has a duration below the predetermined amount of time and/or a duration shorter than the identified stop.

3. The medium of claim 1, wherein a given instance of the route data characterizes a route traversed by a given service crew during a work shift, and the ticket location system identifies a partition of the route data that is traversed during execution of field service for a matched trouble ticket.

4. The medium of claim 1, wherein a subset of the plurality of trouble tickets have at least one of incomplete and inaccurate location data.

5. The medium of claim 1, wherein a subset of the trouble tickets are associated with a lateral or a feeder of the power grid and each of the subset of trouble tickets include a field characterizing a final cause of a fault and the corresponding location of each trouble ticket is also associated with the final cause.

6. The medium of claim 1, wherein a subset of the trouble tickets are associated with a smart meter at a power consuming premises.

7. The medium of claim 1, wherein each instance of route data characterizes data stored by a global navigation satellite system (GNSS) during traversal of a corresponding route.

8. The medium of claim 1, wherein the ticket location system stores each of the plurality of trouble tickets with the associated location and time of the stop in a database.

9. The medium of claim 1, wherein the ticket location system further comprises an historical analyzer that:
identifies a set of trouble tickets that are associated with a same power grid element in the power grid and are associated with locations that are within a proximal area; and
marks the proximal area in the power grid as a potential trouble area.

10. The medium of claim 9, wherein a risk of the potential trouble area corresponds to a number of trouble tickets in the set of trouble tickets within a predetermined time period.

11. A system comprising:
a memory for storing machine executable instructions; and
a processing unit comprising one or more processor cores that access the memory and executes the machine readable instructions, the machine readable instructions comprising:
a ticket location system that:
matches a trouble ticket that is stored in a first electronic record and is issued for a power grid element in a power grid with an instance of route data that is stored in a second electronic record, the instance of route data characterizing a time and date of a route traversed by a service crew during field service for the trouble ticket;
identifies a stop characterized in each instance of the route data, wherein the stop is at least one of a longest stop in the instance of route data and a stop with a duration that exceeds a predetermined amount of time; and
associates the trouble ticket with a location and a time of the stop in the instance of the route data; and
a map system that outputs a map characterizing a geographical representation of a portion of the power grid, the map including visual indicia for the trouble ticket positioned at a location on the map corresponding to the location of the stop associated with the trouble ticket.

12. The system of claim 11, wherein the ticket location system further comprises an historical data analyzer that:
identifies a plurality of sets of trouble tickets that are associated with a same power grid element in the power grid and associated with locations within a proximal area within a predetermined time period; and
marks the proximal area in the power grid for each of the plurality of sets of trouble tickets as a potential trouble area, wherein a risk of each potential trouble area corresponds to a number of trouble tickets in the corresponding set of trouble tickets.

13. The system of claim 12, wherein the map includes a visual indicia that characterizes the risk of each potential trouble area.

14. The system of claim 13, wherein the map system communicates with a ticket system that generates trouble tickets for the power grid, the map system providing a request for a preventative repair procedure to the ticket system for at least one of the potential trouble areas.

15. The system of claim 11, wherein the trouble ticket is associated with a feeder or a lateral of the power grid and the trouble ticket includes a field characterizing a final cause of a fault, and the final cause is associated with the stop on the route in the instance of route data.

16. The system of claim 11, wherein the machine readable instructions further comprises an energy management system that determines an age of the power grid element associated with the trouble ticket based on the time associated with the trouble ticket.

17. A method of initiating a preventative repair procedure for a power grid element comprising:
comparing a plurality of utility server initiated trouble tickets stored in a first set of electronic records that are associated with power grid element events in a power grid with instances of route data stored in a second set of electronic records that characterize routes traversed by a plurality of service crews responding to each of the plurality of trouble tickets to determine service crew stops and locations of the service crew stops; and
initiating, at a map system operating on the utility server, a preventative repair procedure for a given location for a given power grid element in response to an indication output by the map system that at least one service crew stopped at or near the given location during field service of a given trouble ticket of the plurality of trouble tickets.

18. The method of claim 17, wherein at least of the plurality of trouble tickets includes at least one of incomplete and inaccurate location data.

19. The method of claim 18, wherein the preventative repair procedure is initiated in response to a plurality of service crews responding to different trouble tickets of the plurality of trouble tickets associated with the given power grid element stopping at the given location.

20. The method of claim 19, wherein the plurality of trouble tickets and the instances of route data are accumulated at independently operating data gathering systems over a time period greater than an expected life span of a subset of a power grid elements in the power grid.
